(19) United States
(12) Patent Application Publication
(10) Pub. No.: US 2015/0041071 A1
(43) Pub. Date: Feb. 12, 2015

(54) COMPACT EVAPORATOR SYSTEM

(71) Applicant: Caloris Acquisition, LLC, Minnetonka, MN (US)

(72) Inventor: Artur G. Zimmer, Oxford, MD (US)

(73) Assignee: Caloris Acquisition, LLC

(21) Appl. No.: 14/456,475

(22) Filed: Aug. 11, 2014

Related U.S. Application Data
(60) Provisional application No. 61/864,880, filed on Aug. 12, 2013.
(60) Provisional application No. 61/926,018, filed on Jan. 10, 2014.

(51) Int. Cl. B01D 1/30; B01D 1/00

(52) U.S. Cl. CPC B01D 1/305; B01D 1/0094
USPC 159/26.1; 159/31

(57) ABSTRACT

A compact evaporator system is provided having a horizontal vapor separator and a horizontal forced circulation heat exchanger utilizing mechanical vapor recompression. The vapor separator has at least one product chamber having at least one product passage configured to receive at least one product. The vapor separator can also have at least one vapor chamber in fluid communication with the at least one product chamber having at least one vapor passage, wherein the at least one vapor chamber has a substantially horizontal orientation. The vapor separate can be configured such that a portion of the at least one product evaporates in the product chamber to produce a vapor that travels into the at least one vapor chamber, residual entrained droplets are removed from the vapor as it flows laterally through the vapor chamber, and the vapor is then discharged through the at least one vapor passage.

This application claims the benefit of U.S. Provisional Application No. 61/864,880, filed Aug. 12, 2013 and U.S. Provisional Application No. 61/926,018, filed Jan. 10, 2014, which are incorporated herein by reference.

### TECHNICAL FIELD

The present disclosure relates to a compact evaporator system.

### BACKGROUND

Evaporator systems use thermal separation technology and can be used for the concentration or separation of liquid solutions, suspensions and emulsions. During evaporation, a solution is concentrated when a portion of the solvent, usually water, is vaporized, leaving behind concentrate that contains virtually all of the suspended solids, dissolved solids, or solute, from the original feed.

Evaporation is a valuable process technology in a variety of fluid processing applications, particularly where evaporation is considered an alternative process in an increasing number of wastewater treatment applications. It can be effective for concentrating or removing salts, heavy metals and a variety of hazardous materials. Also, it may be used to recover useful by-products from a solution, or to concentrate liquid wastes prior to additional treatment and final disposal. Many applications of the technology also produce a reusable water stream, which is a valuable feature where water conservation is a priority or mandated by local regulations and laws.

A disadvantage of traditional evaporator systems is that they can constitute a significant capital investment that many businesses may not be able to afford. Depending on the capacity required by a process or application, the size of an evaporator system can be large, requiring substantial capital investment to purchase the equipment and for the facility to house the equipment, including ancillary equipment (e.g., feed tanks, heaters, cleaning systems, etc.), and installation (e.g., piping, electrical, etc.).

Many evaporator systems utilizing current technologies (e.g., rising film or falling film) are unable to concentrate to high total solids because of the increase in viscosity that occurs at the higher concentrations. This limitation lowers the economic benefit of the evaporator systems. Therefore, there is a need to improve the technology to make it more versatile, compact, and affordable.

The present disclosure provides and describes a more versatile and compact evaporator system. According to an embodiment of the present disclosure, this can be achieved by a horizontal vapor separator and horizontal forced circulation heat exchanger design.

It is understood that the use of a compact evaporator system of the present disclosure is not limited in its application. The compact evaporator system of the disclosure can be used in a variety of applications, for example, concentration of food and beverage products (e.g., sugars, juices, jellies, purees, pectin, brewer's yeast, beer dealcoholization, beer wort, stillage, coffee, gelatin, mash, starch, yeast extract, dairy products); processing spent liquids in the pharmaceutical and life science industries; concentration of select chemicals; wastewater from chemical processes; metal surface treatment effluent; food processing waste streams; recovering oil and water from emulsions from metal processing operations and foundries used in the automotive industries; concentration of wastewater from dye operations; cleaning waste streams (from component cleaning, tank cleaning, polishing and pretreatment cleaning); recover water from industrial laundries wastewater, boiler and cooling tower blow down; to name just a few.

### SUMMARY

One embodiment of the present disclosure is directed to a vapor separator. The vapor separator can include at least one product chamber having at least one product passage configured to receive at least one product. The vapor separator can also include at least one vapor chamber in fluid communication with the at least one product chamber having at least one vapor passage, wherein the at least one vapor chamber has a substantially horizontal orientation. The vapor separator can be configured such that a portion of the at least one product evaporates in the product chamber to produce a vapor that travels into the at least one vapor chamber, residual entrained droplets are removed from the vapor as it flows laterally through the vapor chamber, and the vapor is then discharged through the at least one vapor passage.

In another embodiment, the vapor separator can further comprise a housing wherein the at least one product passage can be configured to enter the housing near the first end, at the top portion of the housing, and direct the product toward a product inlet distributor. In another embodiment, the housing can further comprise at least one product sump located in the lower section of the at least one product chamber, configured to receive a liquid portion of the at least one product that does not evaporate and form the vapor. In another embodiment, the vapor separator can further comprise at least one removable demister located in the at least one vapor chamber, configured to capture entrained product liquid droplets by contact with the surface of the demister and positioned so the vapor in the at least one vapor chamber is drawn through the at least one demister.

In another embodiment, the product chamber and vapor chamber can be under a partial vacuum. In another embodiment the partial vacuum can range in absolute pressure between about 2 psia and about 14 psia. In another embodiment, the product chamber and vapor chamber can be operated at atmospheric pressure or higher. In another embodiment, the product chamber and vapor chamber can be configured in a substantially horizontal orientation. In another embodiment, the vapor formed in the product chamber can travel laterally into the vapor chamber while the remaining portion of the product representing a majority of the product falls into the liquid sump. In another embodiment, a lower surface of the vapor chamber is slanted toward the product chamber and configured so solvent or product droplets that contact the inner wall of the vapor chamber while being conveyed through the vapor separator by the vapors then flow by gravity downward along the inside cylinder walls of the vapor separator to collect on the lower surface and flow by gravity back into the product chamber and into the liquid sump.

Another embodiment of the present disclosure is directed to a compact evaporator system comprising a vapor separator having at least one product chamber having at least one product passage configured to receive at least one product and at least one vapor chamber in fluid communication with the at least one product chamber having at least one vapor passage, wherein the at least one vapor chamber has a substantially horizontal orientation. The compact evaporator system can be configured such that a portion of the at least one product evaporates in the product chamber to produce a vapor that travels into the at least one vapor chamber, wherein via gravity separation, residual entrained droplets are removed from the vapor as it flows laterally through the vapor chamber, and the vapor is then discharged through the at least one vapor passage. In addition, the compact evaporator system can further comprise a forced circulation heat exchanger comprising an inner shell forming a generally cylindrical tube in a generally horizontal orientation, at least one product pass having a plurality of tubes within the inner shell and a product inlet passage and a product outlet passage configured to circulate at least one product through the plurality of tubes, and a vapor space formed between the inner shell and outer walls of the plurality of tubes. The forced circulation heat exchanger can also include an outer shell forming a generally cylindrical tube configured to encompass a portion of the inner shell and creating at least one bustle, and the at least one bustle comprising at least one vapor inlet duct and at least one vapor opening in communication with the vapor space within the inner shell and a condensate outlet passage. The one embodiment, the compact evaporator system can further include at least one circulation pump and at least one vapor compressor, wherein the evaporator system is configured so that vapor formed in the vapor separator is pumped through the at least one vapor compressor into the at least one bustle and into the vapor space within the inner shell of the heat exchanger to contact the outer walls of the plurality of tubes and form a condensate, while the at least one product is circulated through the at least one product pass of the heat exchanger and the product chamber of the vapor separator.

In another embodiment, the vapor compressor can be configured to receive the vapor from the vapor passage and raise the pressure to a final pressure and discharge the vapor into the at least one bustle. In another embodiment, the compact evaporator system for a nominal water evaporation rate of 1,500 lbs/hour is less than about 90 inches high, less than about 72 inches wide, and less than about 120 inches long. In another embodiment, the vapor separator can operate under a partial vacuum having a range in absolute pressure between about 2 psia and about 14 psia. In another embodiment, the vapor separator can be operated at atmospheric pressure or higher.

In another embodiment, the vapor space within the inner shell of the heat exchanger can operate within a range in absolute pressure between about 3 psia and about 30 psia. In another embodiment, a portion of the concentrate can be bled from the compact evaporator system to maintain a final concentration of the at least one product within the system. In another embodiment, the system can be configured so that the heat balance is positive without employing a heat source external to the evaporator system after establishing steady state operation.

In another embodiment, the present disclosure is directed to a vapor separator. The vapor separator can include at least one product chamber having at least one product passage configured to receive at least one product and at least one vapor chamber in fluid communication with the at least one product chamber having at least one vapor passage, wherein the at least one vapor chamber has a substantially horizontal orientation. The vapor separator can further include a spin vane positioned within the at least one vapor chamber, wherein a portion of the at least one product evaporates in the product chamber to produce a vapor that travels into the at least one vapor chamber through the spin vane causing the vapor to swirl through the vapor chamber such that via centrifugal separation, entrained droplets are removed from the vapor as it flows laterally through the vapor chamber, and the vapor is then discharged through the at least one vapor passage.

Additional objectives and advantages of the present disclosure will be set forth in part in the description which follows, and in part will be obvious from the description, or may be learned by practice of the present disclosure. The objectives and advantages of the present disclosure will be realized and attained by means of the elements and combinations particularly pointed out in the appended claims.

It is to be understood that both the foregoing general description and the following detailed description are exemplary and explanatory only and are not restrictive of the present disclosure as claimed.

The accompanying drawings, which are incorporated in and constitute a part of this specification, illustrate several embodiments of the present disclosure and together with the description, serve to explain the principles of the present disclosure.

### BRIEF DESCRIPTION OF THE DRAWINGS

FIG. 1 is a side perspective view of a compact evaporator system, according to an exemplary embodiment.

FIG. 2 is a flow schematic of a part of a compact evaporator system, according to various embodiments.

FIG. 3 is a side view of a compact evaporator system, according to an exemplary embodiment.

FIG. 4 is a side view schematic drawing of a vapor separator, according to an exemplary embodiment.

FIG. 5 is a side cross-sectional view of part of a vapor separator and product inlet distributor, according to an exemplary embodiment.

FIG. 6A is a side cross-sectional view of part of a vapor separator and product inlet distributor, according to an exemplary embodiment.

FIG. 6B is a top view of part of a product inlet distributor for a vapor separator, according to an exemplary embodiment.

FIG. 7 is a top view of a compact evaporator system, according to an exemplary embodiment.

FIG. 8 is side view schematic drawing of a forced circulation heat exchanger, according to an exemplary embodiment.

FIG. 9 is an end view of a compact evaporator system, according to an exemplary embodiment.

FIG. 10 is a top view of a compact evaporator system, according to an exemplary embodiment.

FIG. 11 is a side view of a compact evaporator system, according to an exemplary embodiment.

FIG. 12A is a side perspective view of a forced circulation heat exchanger of a compact evaporator system, showing some of the internals of the forced circulation heat exchanger, according to an exemplary embodiment.

FIG. 12B is an end view of a forced circulation heat exchanger of a compact evaporator system, according to an exemplary embodiment.

FIG. 13 is a side perspective view of a compact evaporator system, according to an exemplary embodiment.

FIG. 14 is a side perspective view of a compact evaporator system, according to an exemplary embodiment.

FIG. 15 is a side perspective view of a compact evaporator system, according to an exemplary embodiment.

FIG. 16 is a side view schematic drawing of a vapor separator, according to an exemplary embodiment.

FIG. 17 is an isometric view of a spin vane, according to an exemplary embodiment.

### DETAILED DESCRIPTION

The present disclosure is described herein with reference to illustrative embodiments for a particular application. It is understood that the embodiments described herein are not limited thereto. Those having ordinary skill in the art and access to the teachings provided herein will recognize additional modifications, applications, embodiments, and substitution of equivalents that all fall within the scope of the present disclosure. Accordingly, the present disclosure is not limited by the foregoing or following descriptions.

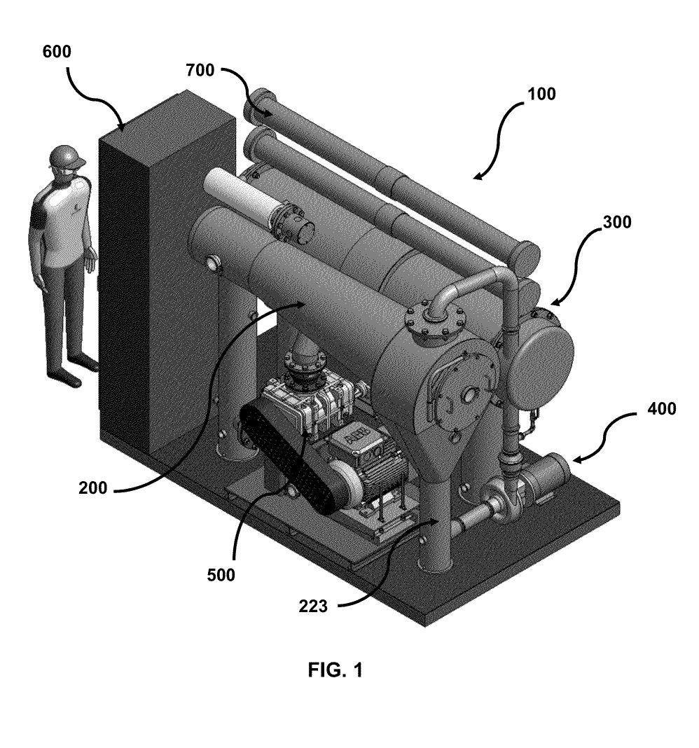

FIG. 1 shows a side perspective view of a compact evaporator system (CES) 100, according to an exemplary embodiment. CES 100 can comprise a vapor separator 200, a forced circulation heat exchanger (FCHE) 300, a circulation pump 400, a vapor compressor 500, a control system 600, and a plurality of inline heaters 700. Other configurations and arrangements of CES 100 are contemplated. CES 100 can be configured to operate using mechanical vapor recompression (MVR) by means of vapor compressor 500, or using steam heating to the FCHE 300 without use of vapor compressor 500. Embodiments of CES utilizing steam heating may also include a surface condenser (not shown).

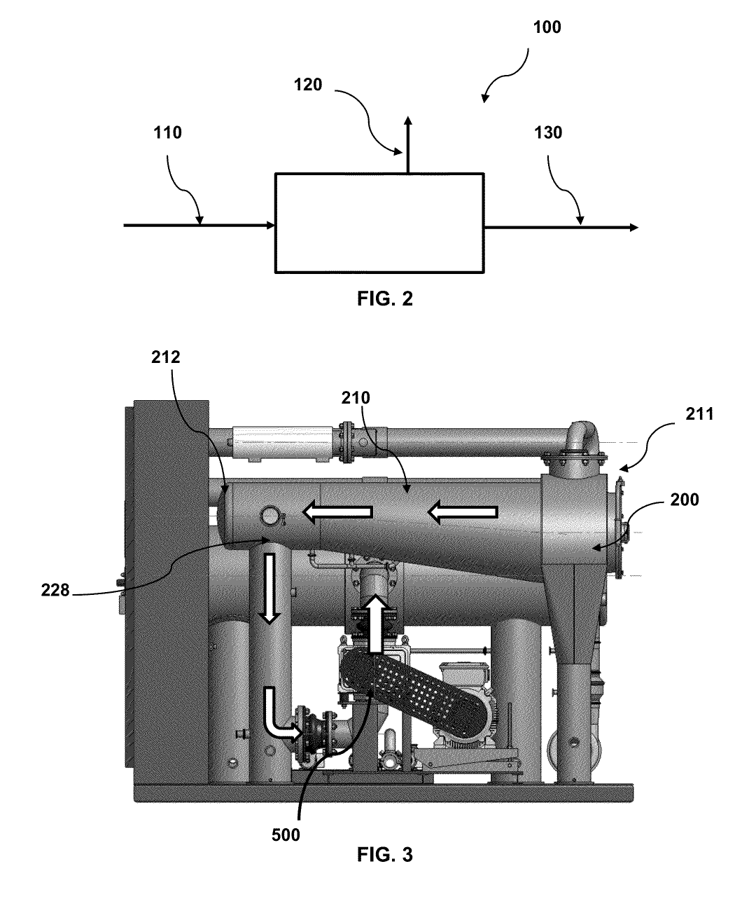

FIG. 2 shows a simplified flow schematic of CES 100, according to various embodiments. In operation, CES 100 can be configured to receive a product 110 (e.g., wastewater, food product, aqueous chemical solution, suspensions, etc.) and process product 110 to produce a concentrate 120 and a condensate 130. The temperature, concentration, and flow rate of product 110, concentrate 120, and condensate 130 can vary based on the application.

According to various embodiments, CES 100 can increase the concentration of product 110 and create concentrate 120 while producing condensate 130 by forced recirculation evaporation. In operation, the total solids (TS) concentration of product 110 can increase until reaching a final TS concentration, which can then constitute concentrate 120 and can be discharged from CES 100. Using circulation pump 400 to produce the forced recirculation can allow product 110 to continue circulation and heat transfer at higher viscosities than would be possible in traditional evaporator systems (e.g., falling or rising film evaporators). This condition can be further taken advantage of by using evaporator tubes with enhanced heat transfer surfaces on the product side (static mixers, corrugated tubes, etc.) Consequently, by operating at viscosities up to (5) times higher than in conventional evaporator systems, correspondingly higher TS concentrations can be achieved. Accordingly, being able to concentrate to higher TS concentrations increases the utility and effectiveness of the CES 100 system.

As the concentration of product 110 increases in CES 100, for certain products, the boiling point can rise due to boiling-point elevation (BPE). To mitigate the impact of BPE, but also of viscosity particularly at or near the final concentration, the evaporation process can be split into two or more product passes. According to one particular embodiment, CES 100 can consist of one product pass. However, according to other embodiments, it is contemplated that multiple product passes may be utilized.

As shown in FIG. 1, CES 100 can be arranged in compact configuration allowing for a reduced dimensional envelope compared to equivalent capacity evaporator systems. This can be achieved through the use of the horizontal separator. For example, CES 100, having a nominal water evaporation capacity greater than or equal to about 1,500 lbs/hr can have a length of less than or equal to about 120 inches, a height less than or equal to about 90 inches, and a width less than or equal to about 72 inches.

### Vapor Separator

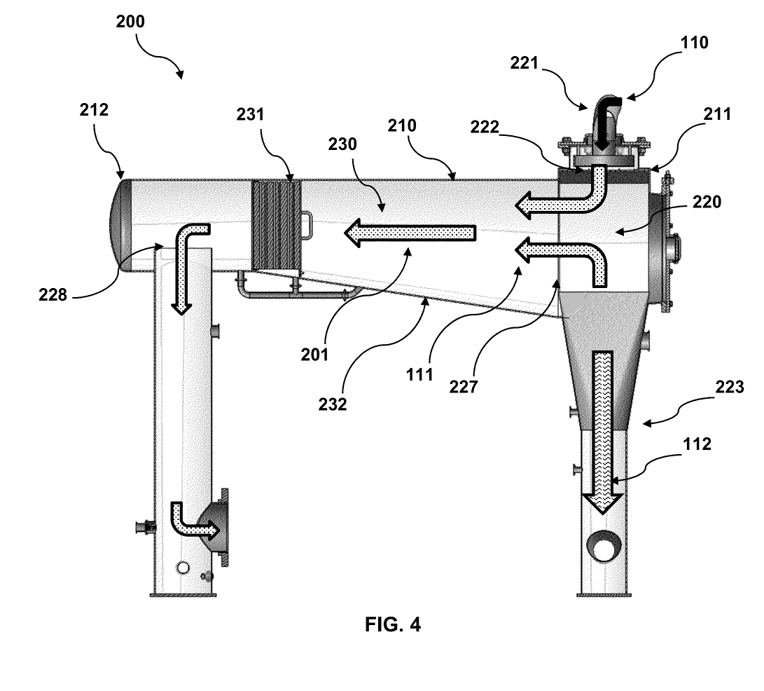

FIG. 3 shows vapor separator 200, according to an exemplary embodiment. Vapor separator 200 can comprise a housing 210, generally cylindrical or another suitable shape. Housing 210 can have a first end 211 and a second end 212. A portion of housing 210 extending from first end 211 toward second end 212 can be conical in shape as shown in FIG. 3. Housing 210 can be configured in a generally horizontal orientation as shown in FIG. 3. By arranging vapor separator 200 in a horizontal orientation as shown in FIG. 3, the height requirement for vapor separator 200 can be less than that of an equivalent capacity vertical vapor separator. By reducing the height requirement for vapor separator 200, the dimensional envelope of the CES 100 can be reduced, and consequently the facilities for housing CES 100 can also be reduced.

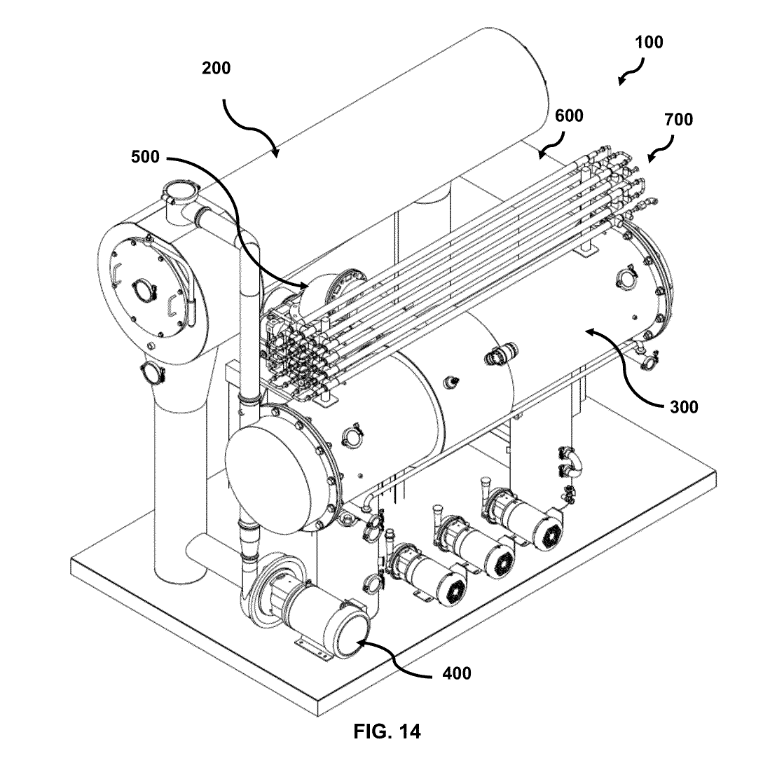

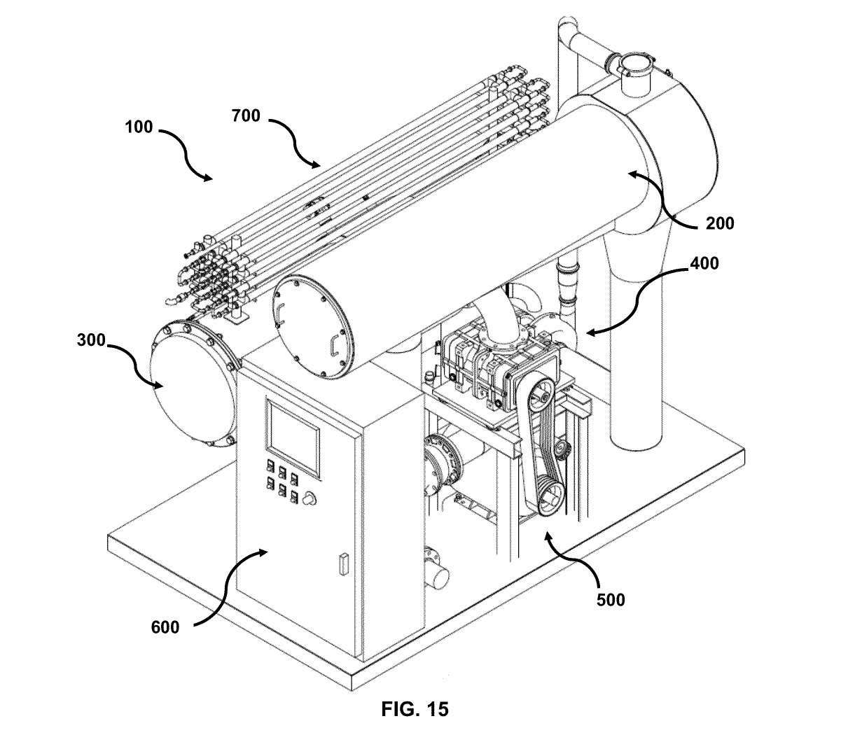

FIGS. 14 and 15 show another CES 100, according to an exemplary embodiment. As shown in FIGS. 14 and 15, CES 100 can have a vapor separator 200, FCHE 300, circulation pump 400, vapor compressor 500, control system 600, and heaters 700. CES 100 as shown in FIGS. 14 and 15 can differentiate from CES 100 shown in FIGS. 1-13 in at least a few ways. For example, vapor separator 200 as shown in FIGS. 14 and 15 can be more cylindrical versus conical shaped. In addition heaters 700 in FIGS. 14 and 15 can include a plurality of smaller heaters configured in series and/or parallel. FIGS. 14 and 15 also shown vapor compressor 500 mounted in a vertical configuration (i.e., compressor mounted above the motor) whereas vapor compressor 500 as shown in FIGS. 1, 3, 11 and 13 show the motor mounted adjacent to the compressor. The different mounting configuration illustrates the versatility of the CES 100 design and the present disclosure is not limited to either mounting configurations, but rather CES 100 can be utilized with numerous compressor configurations.

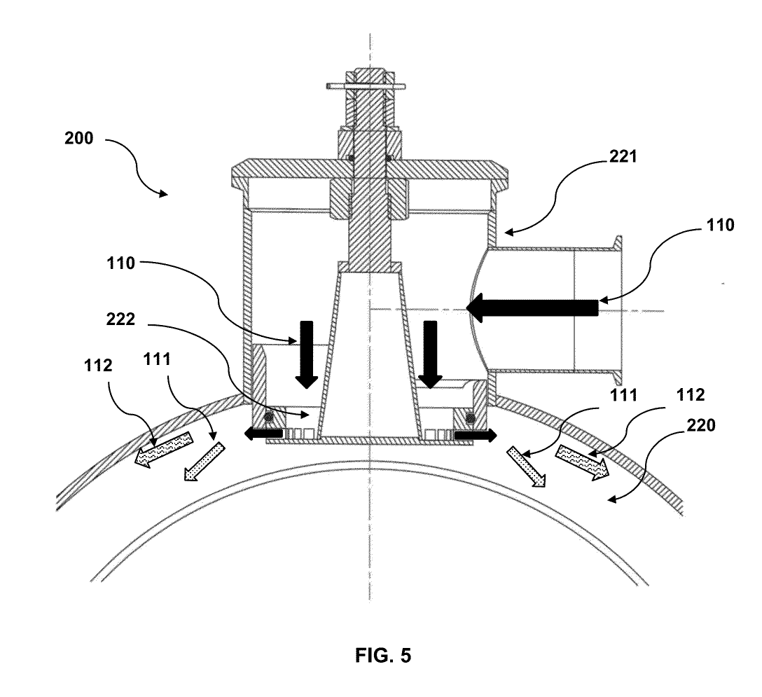

FIG. 4 shows some of the internals of vapor separator 200, according to an exemplary embodiment. Housing 210 can comprise a product chamber 220 and a vapor chamber 230 located adjacent to and in fluid communication with product chamber 220. Product chamber 220 can have a product passage 221 configured to receive product 110. Product passage 221 can be configured to enter housing 210 near first end 211 and at the top portion of housing 210, as shown in FIG. 4.

In addition, within product chamber 220 can be a product inlet distributor 222, as shown in FIGS. 4, 5, 6A, and 6B. A portion of product inlet distributor 222 can be positioned within product passage 221 and a portion within product chamber 220. Product inlet distributor 222 can be configured to receive product 110 and bi-directionally distribute product 110 tangentially toward the inner wall of product chamber 220 and generally perpendicular to the axial length of vapor chamber 230.

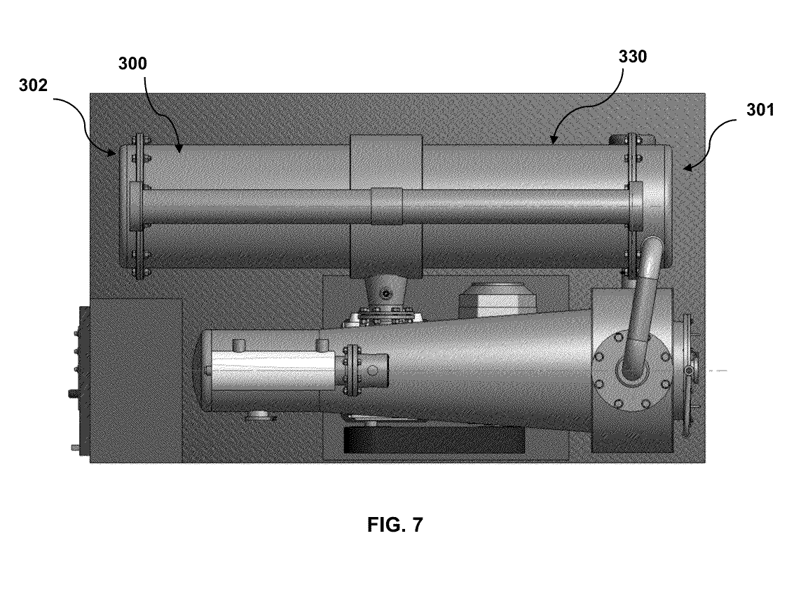

As shown in FIGS. 6A and 6B, the product inlet distributor 222 can comprise a round, rimmed disc 601, which is situated within the cylindrical product passage 221. Rimmed disc 601 can be vertically moved within the cylindrical product passage by means of a threaded bolt 602. In addition, rimmed disc 601 can comprise a plurality of openings 603 as shown in FIGS. 6A and 6B. The plurality of openings 603 can be formed as slits or various other contemplated geometries (e.g., circles, ovals, squares, rectangles, trapezoids, etc.). Product 110 flowing from product passage 221 into product inlet distributor 222 can flow through the plurality of openings 603 and into product chamber 220. Threaded bolt 602 can be configured to control the amount of open cross sectional area of the plurality of openings 603 that are formed in the rim of rimmed disc 602.

Threaded bolt 602 can be configured for manual adjustment, or in other embodiments the movement of threaded bolt 602 can be automatically actuated by a control system. For example, threaded bolt 602 can be actuated to control the differential pressure through the plurality of openings 603. In various other embodiments, thread bolt 602 could be automatically controlled based on a variety of other process variables (e.g., flow rate, viscosity, or other similar variables).

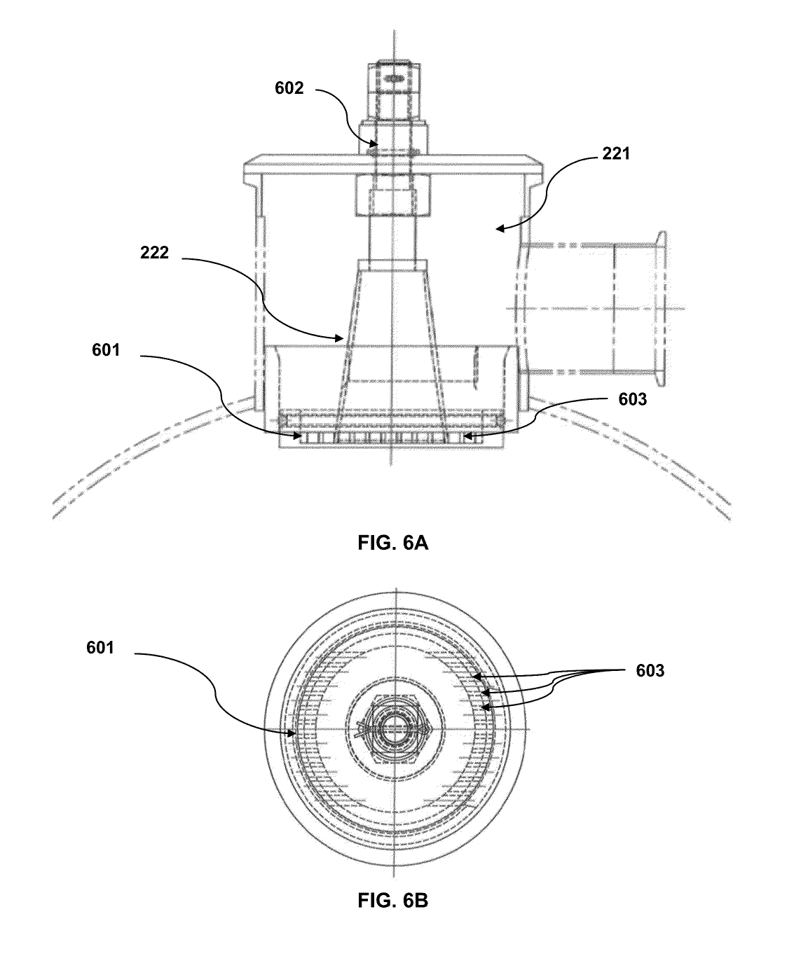

According to various embodiments, the degree of open cross-sectional area for the plurality of openings 603 can be varied, which can allow for adjustments for different products and operating conditions. In addition, the degree of opening and cross-sectional area of each opening 603 can be different than other openings 603. As shown in FIG. 5, the plurality of openings 603 in inlet distributor 222 can guide product 110 toward the curvature of the inner wall of the product chamber 220, in both directions generally perpendicular to a longitudinal axis of the vapor separator 200, which runs from the first end 211 to the second end 212.

As shown in FIG. 5, product 110 as it passes through product passage 221 and plurality of openings 603, and into product chamber 220 can experience a decrease in pressure and a portion (e.g., volatile components) of product 110 can evaporate (e.g., flash evaporate) producing a vapor product 111 and the remaining portion of product 110 can be a liquid product 112, which can have an increased concentration of dissolved and suspended solids. Other than the difference in concentration, it is understood that product 110 and liquid product 112 can be substantially the same. The use of separate terms, for example, product 110 and liquid product 112 is intended for ease of discussion.

In other embodiments, the adjustable plurality of openings 603 of product inlet distributor 222 can further function as an orifice configured to produce a slight backpressure on product 110 upstream of the rimmed disc 601. Producing a slight backpressure can suppress evaporation (e.g., flash evaporation) of liquid volatiles prior to product 110 entering product chamber 220.

Referring back to FIG. 4, product chamber 220 can further comprise a sump 223 located in the lower portion of product chamber 220 configured to collect and contain liquid product 112. Liquid product 112 remaining after the evaporation (e.g., flash evaporation) of a portion of product 110 into vapor product 111 can flow under gravity down the inside wall of product chamber 220 into sump 223, as shown in FIG. 4. The centrifugal force imposed onto product 110 from the velocity of product 110 entering product chamber 220 through openings 603 can keep the majority of liquid product 112 on the inside wall of product chamber 220 where volatile components (i.e., vapor product 111) in liquid product 112 can continue to evaporate (e.g., flash evaporate) from liquid product 112, producing additional vapor product 111. In addition, the flow of liquid product 112 along the inner wall can minimize the splashing that can create entrainment of liquid product 112 droplets into vapor product 111.

As shown in FIG. 4, product chamber 220 can further comprise a vapor window 227 located between product chamber 220 and vapor chamber 230. Vapor window 227 can be configured to allow vapor product 111 to flow from product chamber 220 into vapor chamber 230 through vapor window 227. In addition, vapor window 227 can be configured to limit liquid product 112 from entering vapor chamber 230. For example, vapor window 227 can be configured to minimize the flow of entrained droplets into vapor chamber 230.

Furthermore, a draft 201 can be created within product chamber 220 and vapor chamber 230 that can facilitate the flow of vapor product 111 through vapor separator 200. Draft 201 can draw vapor product 111 from product chamber 220 through vapor window 227 into vapor chamber 230. Within vapor chamber 230, vapor product 111 can undergo at low velocity flow along the horizontal length of vapor chamber 230 toward second end 212. The low velocity flow can cause liquid droplets entrained in vapor product 111 to drop out of the vapor product 111 by gravity (e.g., gravity separation).

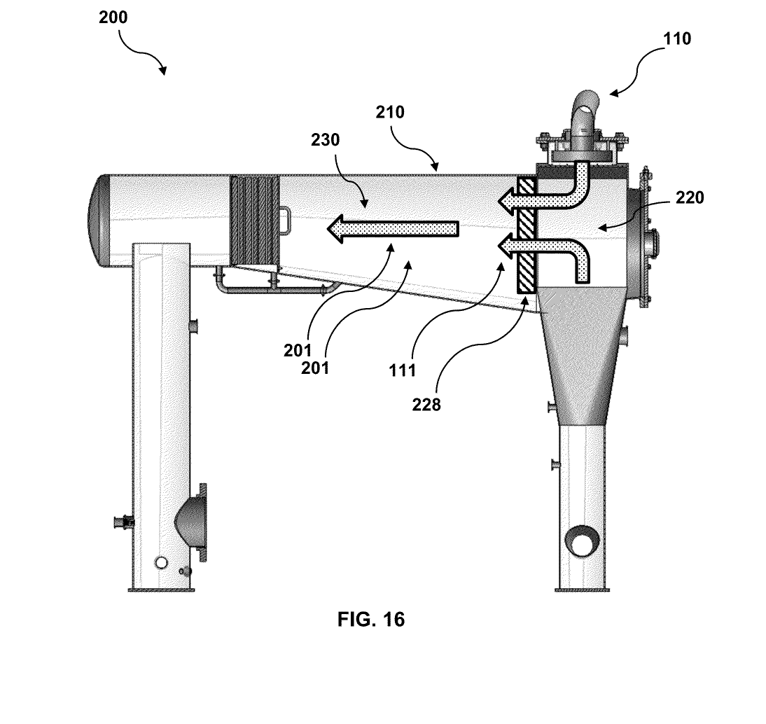

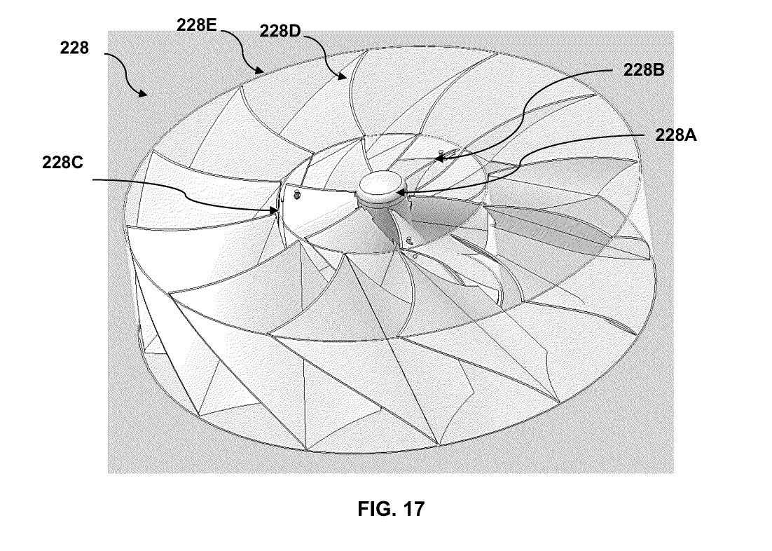

In another embodiment as shown in FIG. 16, CES 100 can further include a spin vane 228. Spin vane 228 can be positioned within vapor chamber 230. For example, spin vane 228 can be positioned in an entrance to vapor chamber 230 from product chamber 220 such that all vapor 111 from product chamber 220 passes through spin vane 228. FIG. 17 illustrates an exemplary embodiment of spin vane 228. Spin vane 228 can be configured such that vapor 111 that travels through spin vane 228 begins to swirl in vapor chamber 230 causing centrifugal acceleration of the entrained droplets toward the inner wall of housing 210 (e.g., centrifugal separation).

Spin vane 228 can be concentric to vapor chamber 230. Spin vane can include a central hub 228A, a plurality of inside blades 228B, an inner guide wall 228C, a plurality of outside blades 228D, and an outer guide wall 228E, as shown in FIG. 17.

Spin vane 228 can be configured such that vapor 111 drawn through spin vane 228 contacts inside blades 228B and outside blades 228D. By contacting inside blades 228B and the outside blades 228D, vapor 111 can be forced to flow parallel along the surface of the blades as vapor 102 can be drawn horizonally through spin 228 vane. As a result, this can cause vapor 111 to exit spin vane 228 tangentially to the surfaces of inside blades 228B and outside blades 228D. Thus, vapor 111 exiting spin vane 228 can enter vapor chamber 230 and rather than just flowing generally in a straight horizontal direction, instead vapor 111 can swirl creating a vortex like effect within vapor chamber 230 as it moves toward second end 212. By swirling within vapor chamber 230 rather than just flowing horizontally, entrained droplets within vapor 111 can be accelerated toward the outer wall of vapor chamber 230 where they can become impinged on the surface and separated from vapor 111 stream. Moreover, as a result of the swirling, entrained droplets are likely to come in contact with one another and coalesce due to the mixing that is occurring. Consequently, as the entrained droplets combine they can increase in size, which can increase their propensity to be accelerated toward the outside wall of vapor chamber 230.

As shown in FIG. 4, vapor chamber 230 lower surface 232 can decline toward first end 211 and product chamber 220. Therefore, liquid droplets that drop out of vapor product 111 (e.g., via gravity separation) or liquid droplets that accelerate and contact the inner surface of vapor chamber 230 (e.g., via centrifugal separation) can collect on lower surface 232 and flow due to gravity back into product chamber 220 and can be collected in sump 223.

Vapor separator 200 can further comprise a demister 231 located in vapor chamber 230. Vapor product 111 can be drawn by draft 201 through demister 231 as shown in FIG. 4. Demister 231 can be configured to capture entrained liquid droplets in vapor product 111 by contact. Liquid droplets captured on demister 231, can coalesce and combine into larger droplets as multiple droplets come into contact with each other, and can drop down via gravity onto the lower surface 232 of housing 210 and flow back into product chamber 220 and be collected in sump 223. In other embodiments (not shown), demister 231 can be removed and vapor can flow to second end 212 without passing through demister 231. It can be advantageous to position the demister close to vapor passage 228 to take advantage of separation by gravity of entrained water droplets within vapor chamber 230.

Near second end 212, vapor product 111 can be drawn by draft 201 from vapor chamber 230 down through vapor passage 228. As shown in FIG. 4, the upper surface of vapor passage 228 can protrude above lower surface 232. Protruding beyond the lower surface of 232 can help prevent liquid droplets collected on lower surface 232 from entering vapor passage 228. The 90 degree turn from vapor chamber 230 into vapor passage 228 may cause remaining liquid droplets to be forced toward second end 212 of vapor separator 200. Impingement forces can make the liquid droplets coalesce and collect and ultimately flow back down lower surface 232 into product chamber 220 and sump 223. Vapor product 111 discharged from vapor passage 228 can be drawn into vapor compressor 500, as shown in FIG. 3.

Vapor separator 200 can utilize gravity forces or partial centrifugal forces for separation of entrained liquid droplets from the flow of vapors. For example, vapor separator 200 as shown in FIG. 4 can utilize gravity forces for separation. In contrast, vapor separator 200 as shown in FIG. 16, which can include spin vane 228 can utilize partial centrifugal forces.

In consideration of the maximum height, length, and width requirements, an overall volume of housing 210 can vary based on the design. In other embodiments, the overall volume and the breakdown of the overall volume into vapor volume and liquid volume can vary. In addition, the length of vapor chamber 230 can be reduced from that which is shown in the exemplary embodiment further reducing the footprint. Furthermore, the height of sump 223 and vapor passage 228 can also be reduced. For example, the height of sump 223 and vapor passage 228 can be based on the space required for installation of vapor compressor 500 underneath vapor separator 200.

Vapor separator 200, according to various embodiments, can be operated under a partial vacuum condition. Vapor compressor 500 can create a partial vacuum condition on the suction side. For example, the partial vacuum, which the vapor compressor 500 above can create, can range in absolute pressure between 8 psia and about 14 psia. In other embodiments, higher vacuum (e.g., 2 psia) can be established with the help of a vacuum pump. In yet another embodiment, vapor separator 200 can be operated at atmosphere or above (e.g., about 15 psia or higher). Operating under a partial vacuum can facilitate the evaporation (e.g., flash evaporation) of product 110 within vapor separator 200 at lower temperature than product boiling temperature at atmospheric pressure, which can be advantageous in respect to fouling, corrosion, process safety, and the like. For example, CES 100 can operate at a product 110 temperature of about 190° F. and about 9 psia. In another embodiment, where product 110 may be sensitive to heat, CES 100 can operate at a product 110 temperature of about 115° F. and about 2 psia. Operating at the lower temperature can require the capacity to be reduced according to the ratio corresponding to the increase in vapor volume at the lower temperature.

Vapor separator 200, as described above and according to an exemplary embodiment, can be configured to receive product 110 from FCHE 300 into product passage 221 and discharge liquid product 112 back into FCHE 300.

### Forced Circulation Heat Exchanger

As shown in FIG. 1, liquid product 112 within sump 223 can be pumped using circulation pump 400 to FCHE 300. According to an exemplary embodiment, FCHE 300 can have at least one product passes 310. In other embodiments, more than one product passes can be utilized, for example, 2, 4, or 6 product passes. Product pass 310 can be configured to circulate liquid product 112 under turbulent flow conditions. As is known to one of skill in the art, operating under turbulent flow conditions increases the rate of heat transfer from the surface of the heat exchanger tubes into the liquid product 112 flowing through the inside of the tubes.

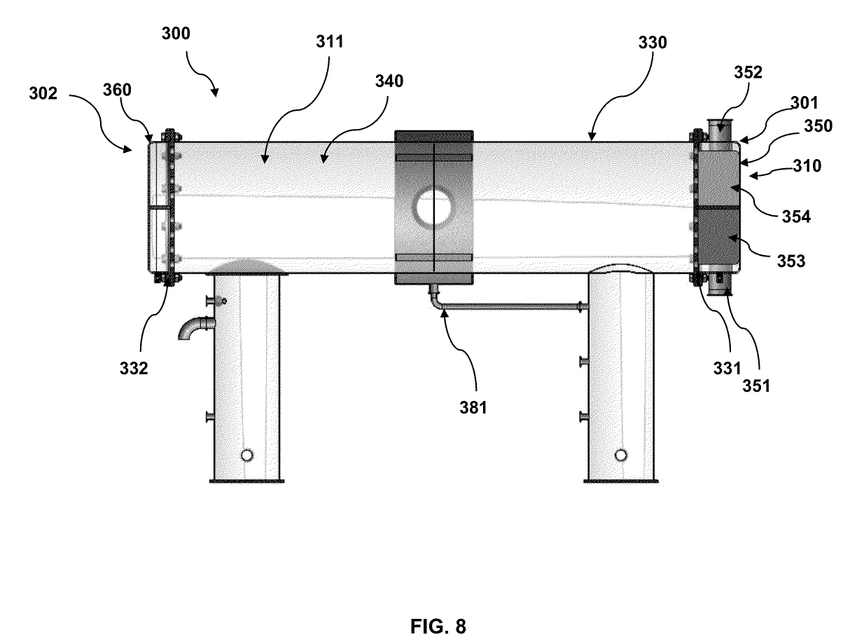

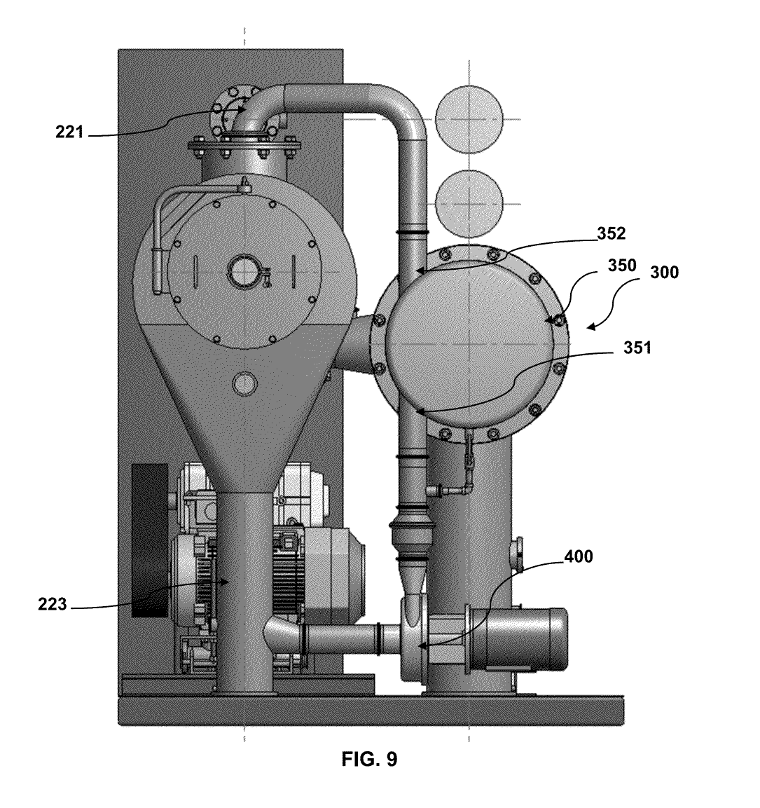

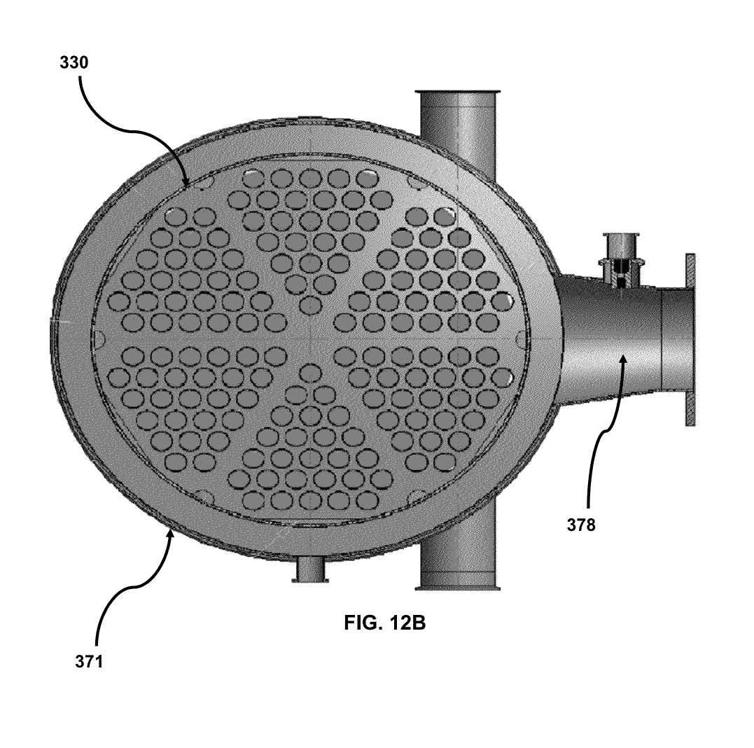

As shown in FIGS. 7 and 8, FCHE 300 can have a first end 301 and a second end 302. FCHE 300 can be arranged in a generally horizontal orientation. Between first end 301 and second end 302, FCHE 300 can comprise an inner shell 330 forming a generally cylindrical tube or another suitable shape. Within inner shell 330, product pass 310 can comprise a plurality of tubes 311 that can run the length of inner shell 330, as shown in FIG. 12 A. One or more of the plurality of tubes 311 can be corrugated tubes and configured to increase rate of heat transfer to liquid product 112 that flows inside the tubes. Alternatively, one or more of the plurality of tubes 311 can have substantially smooth walls (e.g., non-corrugated tubes). The plurality of tubes 311 can comprise a first half plurality of tubes 312, which can be positioned in one half of inner shell 330 and a second half plurality of tubes 313, which can be positioned in the other half of inner shell 330.

In other embodiments, having a plurality of product passes, the inner shell can be split into a greater number of portions to create the first plurality and second plurality of tubes for each of the product passes. For example, for a forced circulation heat exchanger having two separate product passes, the inner shell can be divided in quarters and two of the quarters are configured for the first product pass and the other two quarters are configured for the second product pass.

FCHE 300 can further comprise a pair of tube sheets located at each end of inner shell 330, as shown in FIG. 8. The pair of tube sheets can comprise a first tube sheet 331 located nearest to first end 301 and a second tube sheet 332 can be located nearest to second end 302. First tube sheet 331 can be welded to the end of inner shell 330 at the end nearest the first end 301. Second tube sheet 332 can be welded to the end of inner shell 330 at the end nearest second end 302. The plurality of tubes 311 (not shown within inner shell) can be secured to the first tube sheet 331 by welding or mechanical expansion into the holes in first tube sheet 331. The plurality of tubes 311 can be secured to second tube sheet 332 by welding or mechanical expansion into holes in second tube sheet 332. Welding or otherwise mechanically connecting first tube sheet 331, second tube sheet 332, plurality of tubes 311, and inner shell 330 can create an enclosed vapor space 340 located between the inner wall of inner shell 330 and the outer walls of plurality of tubes 311.

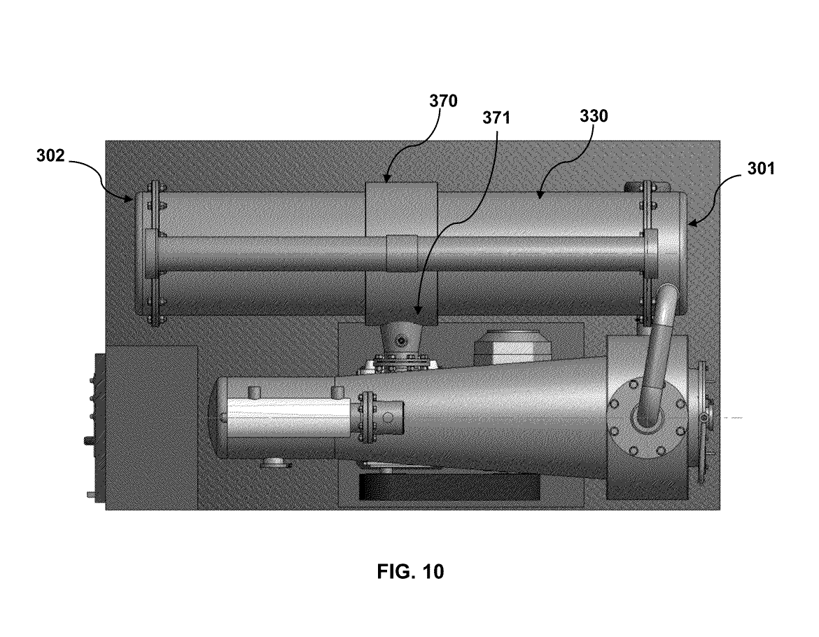

As shown in FIG. 8, FCHE 300 can further comprise a first end products chamber 350 and a second end products chamber 360. First end products chamber 350 can be configured to couple to inner shell 330 in the region of first end 301. As shown in FIG. 9, first end products chamber 350 can comprise a product inlet 351 and a product outlet 352. Product inlet 351 can be in fluid communication with sump 223. Between product inlet 351 and sump 223 can be circulation pump 400 configured to pump liquid product 112 from sump 223 into FCHE 300 product inlet 351. Product outlet 352 can be in fluid communication with product passage 221. Circulation pump 400 can be connected to a motor controlled by a variable frequency drive (VFD). The VFD can be used to control the output of circulation pump 400.

As shown in FIG. 8 or FIG. 12A, first end products chamber 350 can be separated into two separate chambers, product inlet chamber 353 and product outlet chamber 354. Each chamber can be isolated from the other chamber. Product inlet chamber 353 can be configured to receive liquid product 112 through product inlet 351 and allow liquid product 112 to flow into the inlet of product pass 310 by flowing inside first half plurality of tubes 312. Product outlet chamber 354 can be configured to receive liquid product 112 from outlet of product pass 310 and allow liquid product 112 to flow out product outlet 352.

In other embodiments, having a plurality of product passes, the first end products chamber can be split into a greater number of portions to create inlet and outlet chambers for each of the product passes. For example, for a forced circulation heat exchanger having two separate product passes, the first end products chamber can be divided in quarters and two of the quarters are configured for the first product pass and the other two quarters are configured for the second product pass with each product pass having a product inlet chamber with a product inlet, and a product outlet chamber with a product outlet.

Second end products chamber 360, according to an exemplary embodiment, can be configured to re-direct flow of liquid product 112 from the first half of plurality of tubes 312 back through the second half of plurality of tubes 313.

In other embodiments, having a plurality of product passes, the second end products chamber can be split into a greater number of portions to achieve liquid re-direction chambers for each of the product passes. For example, for a forced circulation heat exchanger having two separate product passes, the second end products chamber can be divided in two halves where each half redirects product flow for each of the product passes.

The flow rate of liquid product 112 through product pass 310 can vary. For example, liquid product 112 can be pumped through product pass 310 using circulation pump 400 at flow rates that create product flow velocities in the evaporator tubes in the range of about 2 to about 20 ft/second. The flow rate can be controlled by adjusting the speed of circulation pump 400 by a VFD. The VFD can be controlled and adjust during operation based on evaporator performance variations such as the viscosity of product 110.

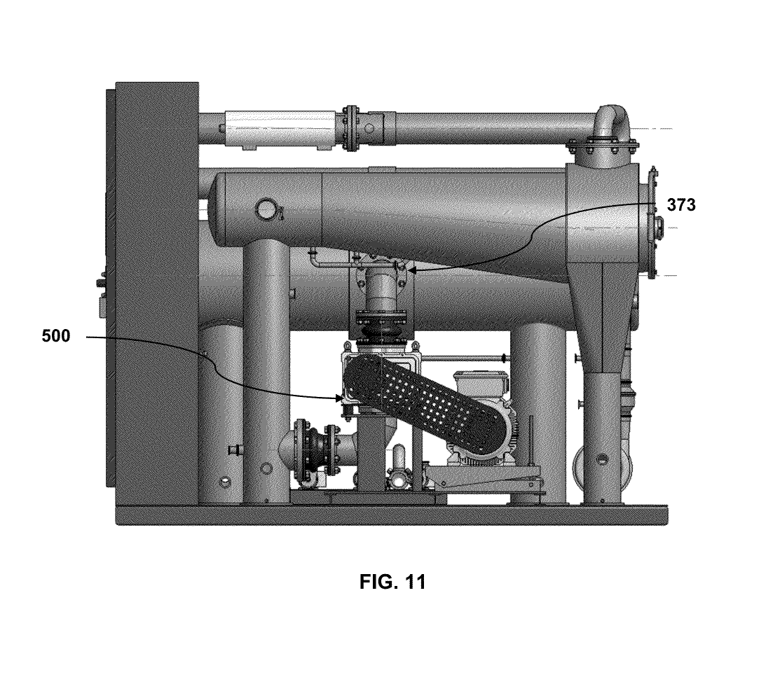

As shown in FIG. 10, FCHE 300 can further comprise an outer shell 370. Outer shell 370 can form a generally cylindrical tube or other suitable shape configured to wrap around a portion of inner shell 330 between first end 301 and second end 302. Each end of outer shell 370 can be sealed to the outside surface of inner shell 330 so the space between inner shell 330 and outer shell 370 is enclosed and forms a bustle 371.

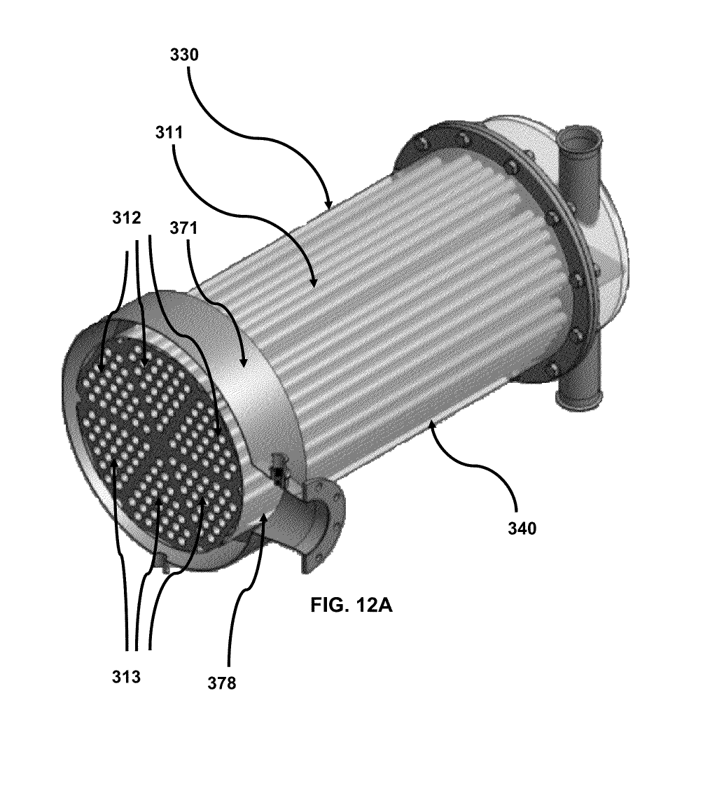

In other embodiments, FCHE 300 can have a plurality of bustles. For example, the space between inner shell 300 and outer shell 370 can form two or more separate bustles by use of a partition. As shown in FIG. 11, bustle 371 can comprise a vapor inlet duct 373. Vapor inlet duct 373 can be in fluid communication with the discharge of vapor compressor 500.

As shown in FIGS. 12A and 12B, FCHE 300 can further comprise a vapor opening 378, which can comprise one or more cutouts through inner shell 330. Vapor opening 378 can be configured to allow passage of vapor product 111 from bustle 371 into vapor space 340. Vapor product 111 within vapor space 340 can contact the outer surface of plurality of tubes 311 of product pass 310. The condensation of vapor product 111 on the outer surface of plurality of tubes 311 can transfer heat through the tubes to the liquid product 112 circulating within the tubes. Vapor product 111 can condense on the tubes and form condensate 130. Condensate 130 can drop by gravity off of the outer surface of plurality of tubes 311 and be collected at the bottom of inner shell 330 and be discharged through a condensate outlet passage 381, as shown in FIG. 8.

The heat transferred from vapor product 111 to liquid product 112 can cause liquid product 112 to increase in temperature while circulating through FCHE 300. Liquid product 112 discharged from FCHE 300 can have a greater temperature than liquid product 112 supplied to FCHE 300. Liquid product 112 discharged from FCHE 300 can be supplied to vapor separator 200 as product 110. Liquid product 112 flow can be facilitated by circulation pump 400.

The rise in temperature of liquid product 112 can depend on many variables. For example, initial temperature of liquid product 112, circulation flow rate, temperature of vapor product 111, flow rate of vapor product 111, a temperature rise at it relates to the achievable flash evaporation rates, fouling of tubes in product passes, concentration of liquid product 112, boiling point elevation, and the like.

### Compressor

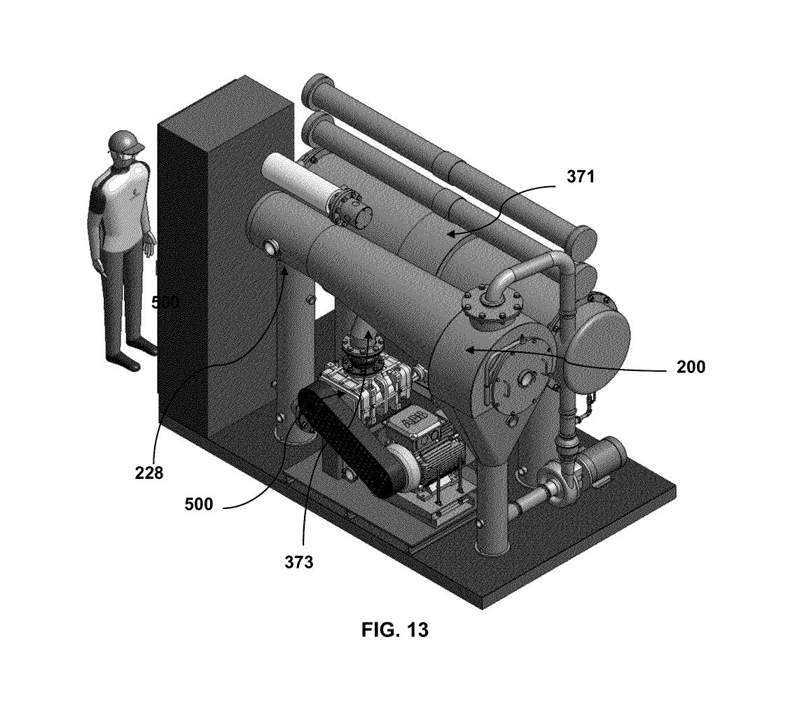

Compressor 500 is shown in FIG. 13, according to an exemplary embodiment. The suction of compressor 500 can be in fluid communication with vapor passage 228 and the discharge of compressor 500 can be in fluid communication with vapor inlet duct 373. Compressor 500 can be connected to a motor controlled by a VFD. The VFD can be used to control the output of compressor 500. Compressor 500 can be configured to increase the pressure of vapor product 111 discharged from vapor separator 200 to an elevated pressure and deliver vapor product 111 at elevated pressure to bustle 371. For example, compressor 500 can receive vapor product 111 at a pressure of between about 2 psia to about 15 psia and increase that pressure to about 4 psia to about 30 psia. In addition, compressor can also add heat to vapor product 111 as it passes through compressor 500. The amount of heat added can mostly be a function of electric power absorbed by compressor 500. Compressor 500, according to an exemplary embodiment can be a rotary lobe compressor. In various other embodiments, compressor 500 can be a rotary screw compressor, reciprocating compressor, rotary vane compressor, centrifugal compressor, or the like.

In yet another embodiment, compressor 500 can be removed from CES 100, and instead a steam source (not shown) may be used as the heating source for the FCHE 300. Steam can be used to directly heat FCHE 300 or in combination with a thermocompressor for better steam economy. This can be beneficial if a readily available low cost steam supply is available. When steam is used, a cooling source (e.g., cold water stream or air cooler) can be used to remove waste heat from the system.

### Operation

When starting CES 100, an initial preheating of product 110 supplied to evaporator system 100 can be conducted by plurality of heaters 700 to raise the temperature of product 110 to the boiling temperature based on the partial vacuum, at which evaporation can commence. Steady state operation can be reached sometime after preheating is initiated. The time to reach steady state operation can depend on many factors, for example, startup heater capacity, product 110 temperature, product 100 concentration, ambient temperature, etc.

According to various embodiments, the level of liquid product 112 in sump 223 can be controlled by pumping or bleeding a portion of liquid product 112 from sump 223, which can constitute concentrate 120. In addition, vapor separator 200 can be configured so that during steady state operation, liquid product 112 within sump 223 can be at a final TS concentration, which is substantially equal to the TS concentration of concentrate 120 that can be discharged from evaporator system 100.

According to various embodiments, once CES 100 has reached steady state, the heat balance within CES 100 can be maintained positive without employing any external heat source.

Vapor separator 200, FCHE 300, and the interconnecting piping can be formed of one or more metals, metal alloys, or super duplex alloys, for example, 304 stainless steel, 316 stainless steel, alloy 2205, alloy 2507, grade 1 titanium, grade 2 titanium, grade 11 titanium, and the like. The material selected can be based on the composition and concentration of product 110, whether the component contacts product 110, and the operating temperatures of CES 100.

According to various embodiments, circulation pump 400 can take the form of a variety of different pumps. For example, centrifugal pump, rotary lobe pump, gear pump, rotary vane pump, and the like.

CES 100, according to various embodiments, can comprise a plurality of instruments (e.g., temperature transmitters, pressure transmitters, mass flow meters, flow meters, conductivity probes and the like) and a plurality of valves (e.g., ball valves, butterfly valves, control valves, pressure relief valves, and the like). The plurality of instruments and valves can be used to control the flow rate, temperature, concentration, levels of the liquid and vapor products within CES 100 as well as the vacuum within CES 100.

Control system 600, as shown in FIG. 1, can be configured to interface with the plurality of instruments, plurality of valves, plurality of pumps and motors to operate CES 100. Control system 600 can include a computer, PLC, or the like that can be programmed to control CES 100 manually, automatically, or a combination of both.

In other embodiments, CES 100 can further comprise additional preheaters and coolers, a feed system having tanks, additional heat exchangers, and the like equipment.

According to various embodiments, CES 100 can be configured to operate in various modes of operation. For example, CES 100 can be operated in a steady state mode or semi-batch mode. Steady state mode can comprise CES 100 continuously receiving product 110 and continuously discharging condensate 130 and concentrate 120 once target concentration of percent TS for concentrate 120 is achieved. Steady state mode can allow for regenerative heating of incoming product 110 feed by way of both the discharged condensate 130 and concentrate 120 through non-contact liquid-liquid heat exchangers, which increases the overall system energy efficiency. Semi-Batch mode can comprise CES 100 intermittently receives product 110 while concentrating product 110 and continuously or intermittently discharging condensate 130, and then discharges all CES 100 contents as concentrate 120 once final concentration % TS is achieved. Following discharge of all CES 100 contents, then the system can restart by refilling with fresh product 110 feed.

According to various embodiments, CES 100 can be configured to be enclosed in a cabinet or other structure. The cabinet can be configured to insulate the sound of the system. In another embodiment, CES 100 can be an open skid and the compressor can be enclosed in a sound insulation box. In yet another embodiment, CES 100 and the compressor can be enclosed in an insulation box.

According to various embodiments, CES 100 can be mobilized for temporary use at different sites. CES 100 can be configured for simple and quick installation. For example, CES 100 can be configured such that CES 100 can operate once receiving an electrical connection, feed connection, vapor condensate discharge connection, and concentrate discharge connection. In other embodiments, additional connections can be made (e.g., drains, cleaning chemicals connections, vent, etc.).

Other embodiments of the present disclosure will be apparent to those skilled in the art from consideration of the specification and practice of the present disclosure disclosed herein. It is intended that the specification and examples be considered as exemplary only, with a true scope and spirit of the present disclosure being indicated by the following claims.

What is claimed is:

1. A vapor separator comprising:
at least one product chamber having at least one product passage configured to receive at least one product; and
at least one vapor chamber in fluid communication with the at least one product chamber having at least one vapor passage, wherein the at least one vapor chamber has a substantially horizontal orientation;
wherein a portion of the at least one product evaporates in the product chamber to produce a vapor that travels into the at least one vapor chamber, residual entrained droplets are removed from the vapor as it flows laterally through the vapor chamber, and the vapor is then discharged through the at least one vapor passage.

2. The vapor separator of claim 1, further comprising a housing wherein the at least one product passage is configured to enter the housing near the end, at the top portion of the housing, and direct the product toward a product inlet distributor.

3. The vapor separator of claim 1, wherein the housing further comprises at least one product sump located in the lower section of the at least one product chamber configured to receive a liquid portion of the at least one product that does not evaporate and form the vapor.

4. The vapor separator of claim 1, further comprising at least one removable demister located in the at least one vapor chamber configured to capture entrained product liquid droplets by contact with the surface of the demister pad and positioned so the vapor in the at least one vapor chamber is drawn by a vapor draft through the at least one demister.

5. The vapor separator of claim 1, wherein the product chamber and vapor chamber are under a partial vacuum.

6. The vapor separator of claim 5, wherein the partial vacuum ranges in absolute pressure between about 2 psia and about 14 psia.

7. The vapor separator of claim 1, wherein the product chamber and vapor chamber are configured in a substantially horizontal orientation.

8. The vapor separator of claim 1, wherein the vapor formed in the product chamber travels laterally into the vapor chamber while the remaining portion of the product falls into a liquid sump.

9. The vapor separator of claim 1, wherein a lower surface of the vapor chamber is slanted toward the product chamber and configured so any solvent or product droplets that contact on the inner wall of the vapor chamber collect on the lower surface and flow back into the product chamber and into a liquid sump.

10. The vapor separator of claim 1, wherein the residual entrained droplets are separated via gravity separation exclusively.

11. A compact evaporator system comprising:
a vapor separator comprising:
at least one product chamber having at least one product passage configured to receive at least one product; and
at least one vapor chamber in fluid communication with the at least one product chamber having at least one vapor passage, wherein the at least one vapor chamber has a substantially horizontal orientation;
wherein a portion of the at least one product evaporates in the product chamber to produce a vapor that travels into the at least one vapor chamber, wherein via gravity separation, residual entrained droplets are removed from the vapor as it flows laterally through the vapor chamber, and the vapor is then discharged through the at least one vapor passage;
a forced circulation heat exchanger comprising:
an inner shell forming a generally cylindrical tube in a generally horizontal orientation;
at least one product pass having a plurality of tubes within the inner shell and a product inlet passage and a product outlet passage configured to circulate at least one product through the plurality of tubes;
a vapor space formed between the inner shell and outer walls of the plurality of tubes;
an outer shell forming a generally cylindrical tube configured to encompass a portion of the inner shell and creating at least one bustle, and the at least one bustle comprising at least one vapor inlet duct and at least one vapor opening in communication with the vapor space within the inner shell; and
a condensate outlet passage;
at least one circulation pump; and
at least one vapor compressor;
wherein the evaporator system is configured so that vapor formed in the vapor separator is pumped through the at least one vapor compressor into the at least one bustle and into the vapor space with the inner shell to contact the outer walls of the plurality of tubes and form a condensate, while the at least one product is circulated through the at least one product pass and the product chamber.

12. The compact evaporator system of claim 11, wherein the vapor compressor is configured to receive the vapor from the vapor passage and raise the pressure to a final pressure and discharge the vapor into the at least one bustle.

13. The compact evaporator system of claim 11, wherein the compact evaporator system has a nominal water evaporation capacity greater than or equal to about 1,500 lbs/hr and is less than about 90 inches high, less than about 72 inches wide, and less than about 120 inches long.

14. The compact evaporator system of claim 11, wherein the vapor separator operates under a partial vacuum having a range in absolute pressure between about 2 psia and about 14 psia.

15. The compact evaporator system of claim 11, wherein the vapor space with the inner shell operates within a range in absolute pressure between about 2 psia and about 30 psia.

16. The compact evaporator system of claim 11, wherein a portion of the concentrate is bled from the compact evaporator system to maintain a final concentration of the at least one product within the system.

17. The compact evaporator system of claim 11, wherein the system is configured so that the heat balance is positive without employing a heat source external to the evaporator system after establishing steady state operation.

18. A vapor separator comprising:
at least one product chamber having at least one product passage configured to receive at least one product;
at least one vapor chamber in fluid communication with the at least one product chamber having at least one vapor passage, wherein the at least one vapor chamber has a substantially horizontal orientation; and
a spin vane positioned with the at least one vapor chamber;
wherein a portion of the at least one product evaporates in the product chamber to produce a vapor that travels into the at least one vapor chamber through the spin vane causing the vapor to swirl through the vapor chamber such that via centrifugal separation, at least a portion of any entrained droplets are removed from the vapor as it flows laterally through the vapor chamber, and the vapor is then discharged through the at least one vapor passage.

19. The vapor separator of claim 18, wherein the spin vane is positioned in an entrance to the vapor separator from the product chamber such that all the vapor from the product chamber passes through the spin vane.
